(19) United States
(12) Patent Application Publication
(10) Pub. No.: US 2024/0335045 A1
(43) Pub. Date: Oct. 10, 2024

(54) PATIENT SUPPORT APPARATUS

(71) Applicant: Stryker Corporation, Kalamazoo, MI (US)

(72) Inventors: Justin Boogaart, Byron Center, MI (US); Hallie Miller, Galesburg, MI (US); Shane Demitruk, Elkhart, IN (US); Tyson Helmke, Elkhart, IN (US)

(21) Appl. No.: 18/621,709

(22) Filed: Mar. 29, 2024

Related U.S. Application Data
(60) Provisional application No. 63/457,843, filed on Apr. 7, 2023.

(51) Int. Cl. A47C 7/54; A61G 5/12

(52) U.S. Cl. CPC A47C 7/543; A61G 5/125

(57) ABSTRACT

A patient support apparatus with a rotatable armrest is provided. The armrest may be configured to facilitate egress and ingress from a front portion of the patient support apparatus, and the armrest may be configured to rotate to a raise position that enables a patient to egress or ingress relative to a side of the patient support apparatus.

### TECHNICAL FIELD

The present disclosure relates to a patient support apparatus, and more particularly to a medical recliner chair with a movable armrest.

### BACKGROUND

It is well known in the medical field that a patient's recovery time can be improved if the patient becomes more mobile. However, egress or exit from a conventional hospital bed can be challenging. One step on the pathway to becoming more mobile is to have a patient be transitioned to sitting in a chair, for example a reclining chair, for at least part of the time. Despite their use, conventional chairs can also be challenging for the patient to ingress and egress.

### SUMMARY

In general, one aspect of the subject matter described herein can be embodied in a patient support apparatus including a frame and a stationary member mounted relative to the frame. The patient support apparatus may include an armrest rotatably mounted to the stationary member and being rotatable between an armrest position and a raised position. The patient support apparatus may include a lift assist member connected between the frame and the armrest. The lift assist member may be operable to aid rotation of the armrest from the armrest position to the raised position. The lift assist member may be operable to allow unassisted rotation of the armrest toward the armrest position.

The foregoing and other embodiments can each optionally include one or more of the following features, alone or in combination. In particular, one embodiment includes all the following features in combination.

In one aspect, the patient support apparatus may include a seat operable to support a patient between first and second opposing sides of the patient support apparatus. The seat may include an upper support surface. The patient support apparatus may include a backrest operable to support a back of the patient between the first and second opposing sides of the patient support apparatus. The backrest may include a back support surface.

In one aspect, in a raised position, the armrest may provide unobstructed access for the patient between one of the first and second opposing sides and the upper support surface and the back support surface. With the armrest in the raised position, the patient may be free to ingress or egress to one of the first and second opposing sides of the patient support apparatus.

In one aspect, with the armrest in the raised position, a lower surface of the armrest may provide unobstructed access to the back support surface from one of the first and second opposing sides, and where, with the armrest in the armrest position, an upper surface of the armrest provides an arm support surface for the patient.

In one aspect, the backrest may be operable to pivot away from the seat to allow the patient to sit in a reclined position.

In one aspect, the lift assist member may be an assist linkage connected between the frame and the armrest.

In one aspect, the assist linkage may be operatively coupled to a pivot member of the armrest.

In one aspect, a pivot joint may be provided between the pivot member and the stationary member to facilitate rotation of the armrest about a pivot axis of the pivot joint.

In one aspect, the patient support apparatus may include a pin offset from the pivot axis of the pivot joint, and a curved slot operable to receive the pin. The curved slot may include a first end configured to engage the pin to limit rotation of the armrest about the pivot axis.

In one aspect, the patient support apparatus may include a locking mechanism operable to secure and release the armrest from the armrest position, a striker receivable by the locking mechanism to secure the armrest in the armrest position, and a manually operable release coupled to the locking mechanism. The manually operable release may be configured to operate the locking mechanism to release the striker and allow the armrest to rotate toward the raised position.

In one aspect, the locking mechanism may be connected to the frame, and the striker may be connected to the armrest.

In general, one aspect of the subject matter described herein can be embodied in a patient support apparatus may include a frame and a stationary member mounted relative to the frame. The patient support apparatus may include an armrest rotatably mounted to the stationary member and being rotatable between an armrest position and a raised position. The patient support apparatus may include a locking mechanism operable to secure and release the armrest from the armrest position, a striker receivable by the locking mechanism to secure the armrest in the armrest position, and a manually operable release coupled to the locking mechanism. The manually operable release may be configured to operate the locking mechanism to release the striker and allow the armrest to rotate toward the raised position.

The foregoing and other embodiments can each optionally include one or more of the following features, alone or in combination. In particular, one embodiment includes all the following features in combination.

In one aspect, the locking mechanism may be connected to the frame, and the striker may be connected to the armrest.

In one aspect, the manually operable release may be positioned substantially out of reach with respect to a patient sitting in the patient support apparatus to limit an ability of the patient to operate the locking mechanism to move the armrest from the armrest position.

In general, one aspect of the subject matter described herein can be embodied in a patient support apparatus may include a frame and a stationary member mounted relative to the frame. The patient support apparatus may include a backrest operable to support a back of a patient between first and second opposing sides of the patient support apparatus, and a seat operable to support the patient between the first and second opposing sides of the patient support apparatus. The backrest may include a back support surface, and the seat may include an upper support surface provided between the back support surface and a front portion of the patient support apparatus.

In one aspect, the patient support apparatus may include an armrest rotatably mounted to the stationary member and being rotatable between an armrest position and a raised position. The armrest may include an arm support surface configured to support an arm of the patient. The arm support surface may include a rear segment proximal to the backrest, a forward segment distal from the backrest, and a medial segment between the rear segment and the forward segment. The forward segment may be higher than the medial segment relative to the upper support surface.

The foregoing and other embodiments can each optionally include one or more of the following features, alone or in combination. In particular, one embodiment includes all the following features in combination.

In one aspect, the forward segment may be sloped upward from a first portion of the forward segment that is proximal to the medial segment to a second portion of the forward segment that is distal from the medial segment.

In one aspect, the medial segment may include a midpoint of the arm support surface between a first end of the arm support surface that is proximal to the backrest and a second end of the arm support surface that is distal from the backrest.

In one aspect, the rear segment may slope downward from a first portion of the rear segment that is proximal to the medial segment to a second portion of the rear segment that is distal from the medial segment.

In one aspect, the forward segment may be raised relative to the medial segment and may facilitate ingress and egress with respect to the patient support apparatus.

In one aspect, the patient support apparatus may include a lift assist member connected between the frame and the armrest. The lift assist member may be operable to aid rotation of the armrest from the armrest position to the raised position. The lift assist member may be operable to allow unassisted rotation of the armrest toward the armrest position.

Before the embodiments of the disclosure are explained in detail, it is to be understood that the disclosure is not limited to the details of operation or to the details of construction and the arrangement of the components set forth in the following description or illustrated in the drawings. The disclosure may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting one or more embodiments to any specific order or number of components. Nor should the use of enumeration be construed as excluding from the scope of an embodiment any additional steps or components that might be combined with or into the enumerated steps or components.

### BRIEF DESCRIPTION OF THE DRAWINGS

FIG. 1 shows a perspective view of a patient support apparatus.

FIG. 2 shows a side view of the patient support apparatus of FIG. 1 with visibility for internal components.

FIG. 3 shows a side view of the patient's support apparatus of FIG. 1.

FIG. 4 four shows a partial view of the patient support apparatus in FIG. 2.

FIG. 5 shows a perspective view of the patient support apparatus with an armrest pivoted to ½ raised position and with visibility for internal components.

FIG. 6 shows a partial view of the patient support apparatus in FIG. 5.

FIG. 7 shows a perspective view of the patient's support apparatus with an armrest pivoted to a raised position and with visibility for internal components.

FIG. 8 shows a partial view of the patient support apparatus in FIG. 7.

FIG. 9 shows a partial view of a locking mechanism of a patient support apparatus.

FIG. 10 shows a partial view of the locking mechanism in FIG. 9.

### DETAILED DESCRIPTION

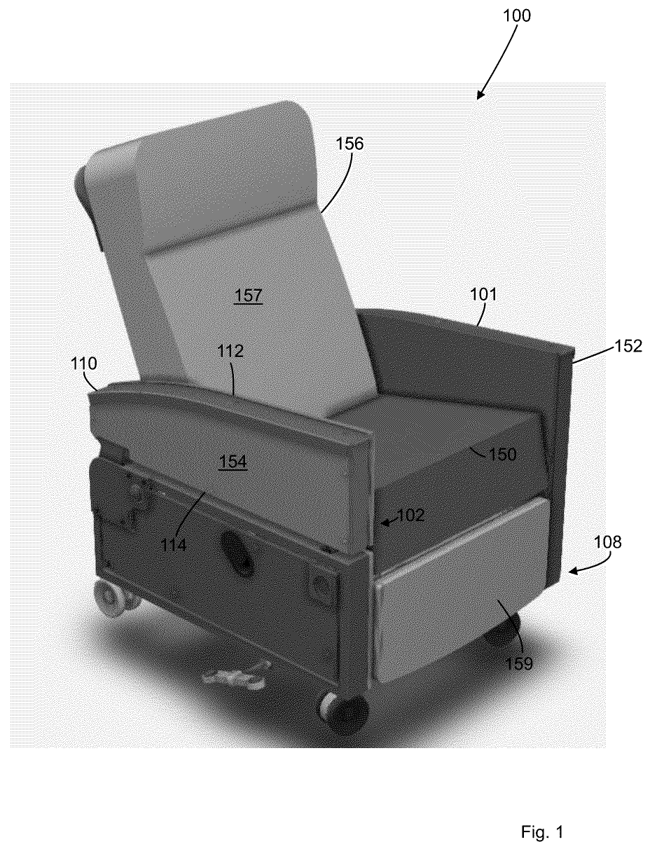

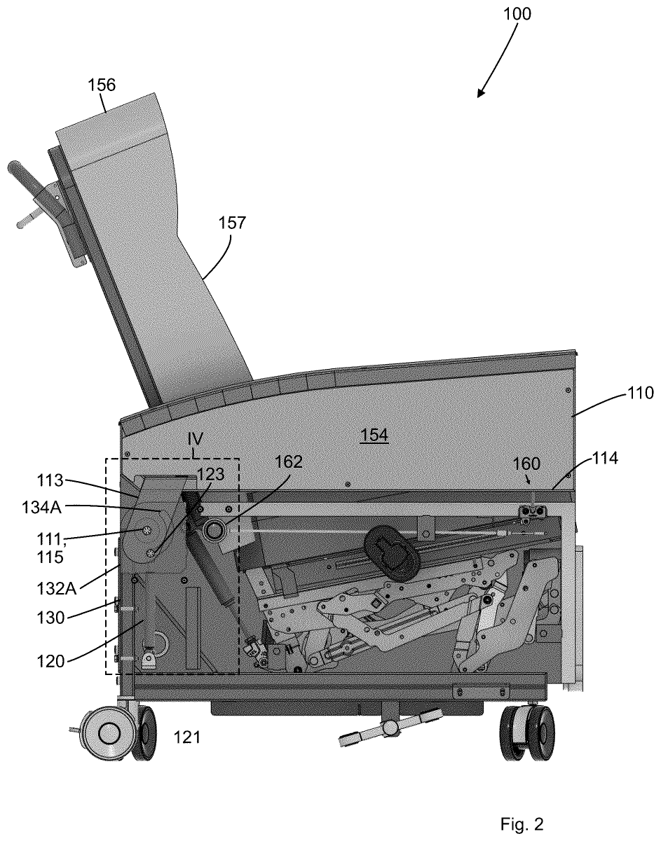

A patient support apparatus and accordance with one embodiment is depicted in FIGS. 1-10 and generally designated 100. The patient support apparatus 100 is shown in the form of a medical recliner chair that can be reconfigured between a seated configuration as shown and one or more reclined positions, including a substantially reclined position with a foot rest also in a raised position. The foot rest of the patient support apparatus 100 may be movable independent of the backrest and between a lowered position and a raised position operable to support at least a portion of a patient's feet and/or legs. In this way, the seat and backrest of the patient support apparatus 100 may articulate in a manner that provides a configuration considered comfortable by the patient. The patient support apparatus 100 may include a frame 130, such as a chassis frame, that supports portions of the patient support apparatus 100, such as a seat 150, a backrest 156, and an armrest 110.

In one aspect, the patient support apparatus 100 may include an armrest 110 that is rotatable and configured to facilitate egress and ingress proximal to a front portion 108 of the patient support apparatus 110. Additionally, or alternatively, the armrest 110 may be configured to rotate to a raised position 104 that enables a patient to egress or ingress relative to a side of the patient support apparatus 100.

As described in more detail herein, the patient support apparatus 100 includes a seat 150 with an upper support surface 151 and a backrest 156 with a back support surface 157. The patient support apparatus 100 also includes a foot rest 159, as described previously. The seat 150, the backrest 156, and the foot rest 159 are disposed between opposing first and second sides 152, 154 of the patient support apparatus 100. Although the foot rest 159 is described herein as being movable between lowered and raised positions, it is to be understood that the foot rest 159 may be configured differently, including, for instance, a fixed, lowered position construction.

The patient support apparatus 100 in the illustrated embodiment includes an armrest 110 that is movable relative to the seat 150 of the patient support apparatus 100. For instance, the armrest 110 may rotate from an armrest position 102 (e.g., a lowered positioned) to a raised position 104. Rotation may be facilitated in a variety of ways, including an armrest 110 configured according to one or more aspects described herein. It is to be understood that there are several aspects of the armrest 110 provided in the present disclosure, and that the armrest 110 and/or the patient support apparatus 100 may be configured to include any one or more aspects, or a feature(s) thereof, described herein and one or more aspects, or a feature(s) thereof, described in conjunction with each other may be absent in the armrest 110 and/or the patient support apparatus 100. For instance, the armrest 110 and/or the patient support apparatus 100 may include a) a first aspect, or a feature thereof, described in one embodiment along with a second aspect, or a feature thereof, and b) a third aspect, or a feature thereof, described in another embodiment along with a fourth aspect, or feature thereof, where both the second and fourth aspects, or features thereof, are absent from the armrest 110 and/or the patient support apparatus 100.

The patient support apparatus 100 in the illustrated embodiment includes a fixed armrest 101 operable to support a patient's arm in a manner similar to the armrest 110 in the lowered or armrest position 102. In an alternative embodiment, the fixed armrest 101 of the patient support apparatus 100 may instead correspond to an armrest 110 constructed according to one or more embodiments of the armrest 110 described herein. For instance, the fixed armrest 101 and the armrest 110 may be provided on opposite sides as shown, or the patient support apparatus 100 may include two armrests 110 on opposites sides instead of a fixed armrest 101.

The armrest 110 may be sized so that it has a length X defined between first and second ends of the armrest 110, which are respectively identified as rear and forward ends 181, 189. The overall length of an arm support surface 112 of the armrest 110 may be greater than the length X, as described herein, due at least in part to curvature and/or slope of the arm support surface 112 deviating from a longitudinal axis 196 of the armrest 110.

The fixed armrest 101 may be constructed with a length and upper surface similar in construction to the armrest 110.

With the armrest 110 in the armrest position 102, the arm support surface 112 of the armrest 110 may be provided at a height relative to the upper support surface 151 substantially sufficient to prevent a patient from egressing from the patient support apparatus 100 toward one of the first and second sides 152, 154 of the patient support apparatus 100. The armrest 110 may be rotated to a raised position 104 to enable egress and ingress of the patient from one of the first and second sides 152, 154 onto or from the upper support surface 151. This type of egress or ingress may be conducted without the patient traversing over the armrest 110 from one of the first and second sides 152, 154. In FIG. 1, the armrest 110 is disposed on the second side 154 of the patient support apparatus 100, and the fixed armrest 101 is disposed on the first side 152 of the patient support apparatus 100; however, the patient support apparatus 100 may be configured differently and the positions of the armrest 110 and the fixed armrest 101 may be reversed.

When the armrest 110 is in the raised position 104, as noted herein, the patient can egress or ingress with respect to the seat 150 from a second side 154 of the patient support apparatus 100. The armrest 110 in the raised position 104 may align with the backrest 156 instead of extending further outward from the second side 154, and therefore moving the armrest 110 to the raised position 104 allows ingress or egress without substantially increasing a foot space or footprint associated with the patient support apparatus 100.

The backrest 156 in FIG. 1 may be configured to pivot to a reclined position. The armrest 110 in the raised position 104 may clear the back support surface 157 (whether upright or reclined) to enable ingress or egress relative from the second side 154 and relative to the back support surface 157 and the upper support surface 151 for the patient. Accordingly, the pivoting construction of the backrest 156 and the armrest 110 may enable a reclined transfer of a patient to or from the patient support apparatus 100. The armrest 110 in one aspect may pivot to the raised position 104 at an angle of approximately 130 deg. relative to the armrest position 102. It is to be understood that the present disclosure is not limited to an angle of 130 deg. and that the angle may be different depending on the application, including larger or smaller angles.

### I. Assisted Rotation

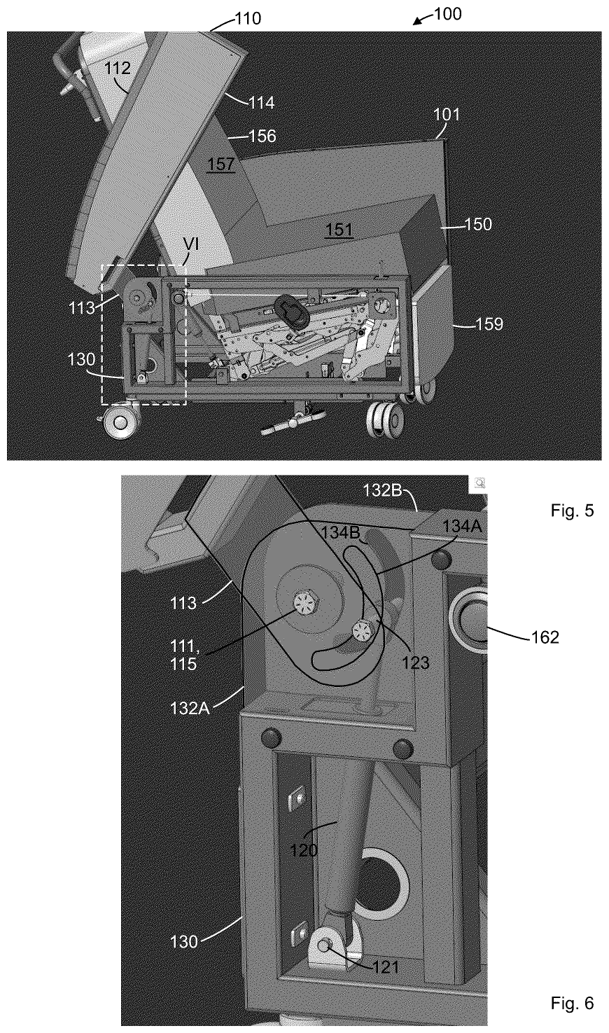

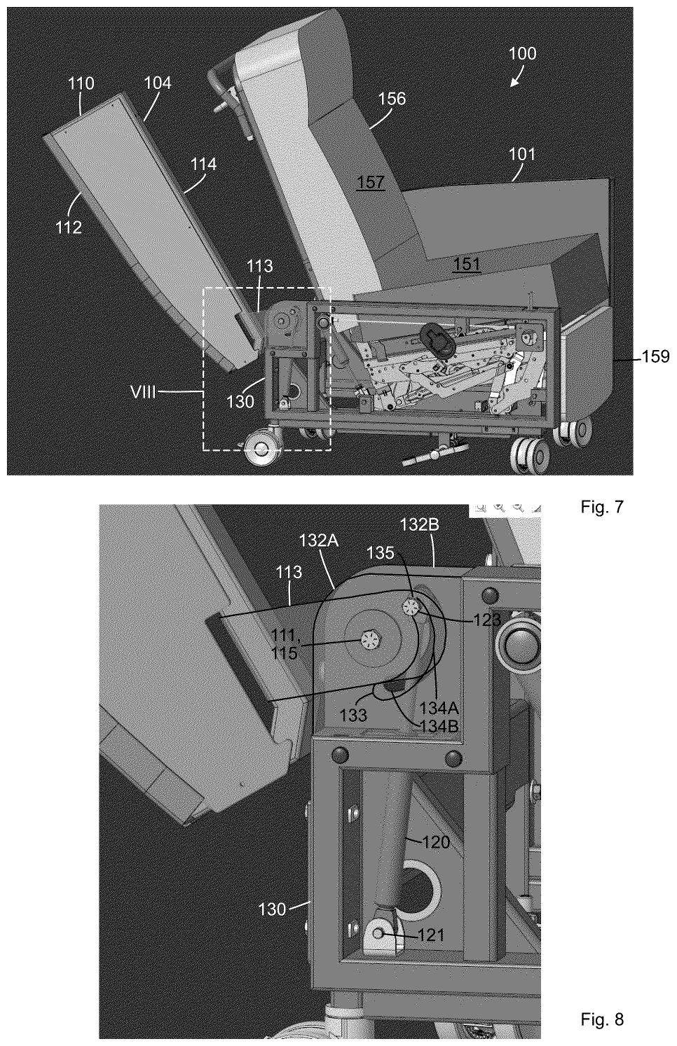

In one aspect of the present disclosure, the patient support apparatus 100 may be constructed to provided assisted rotation of the armrest 110 from the armrest position 102 to the raised position 104. As described herein, with the armrest 110 in the raised position 104, the armrest 110 may clear and/or provide access from the side with respect to the upper support surface 151 of the seat 150. Optionally, with the armrest 110 in the raised position 104, the armrest 110 may also clear and/or provide access from the side with respect to the back support surface 157. A half-raised configuration is depicted in FIG. 5 with the armrest 110 clearing the upper support surface 151 of the seat 150. And in FIG. 7, the armrest 110 is shown in the raised position 104 with the armrest 110 clearing the upper support surface 151 of the seat 150 and the back support surface 157 of the backrest 156.

Assisted rotation and operation of the armrest 110 may be provided via a variety of constructions, as described herein. It is noted that the armrest 110 construction is not limited to any particular arrangement of constructions or aspects described herein. For instance, the armrest 110 may be constructed according to a subset of aspects or features described herein.

In one aspect of the armrest 110, the patient support apparatus 100 may include a locking mechanism 160 operable to secure the armrest 110 in the armrest position 102 and to release the armrest 110 in response to user activation of a lock release input 162, enabling for rotation to the raised position 104. Additional and alternative aspects of the locking mechanism 160 are described in further detail herein.

In one aspect of the armrest 110, with the armrest 110 free to rotate from the armrest position 102 to the raised position 104, such as by release of the locking mechanism 160, the armrest 110 may be rotated by a caregiver or a patient.

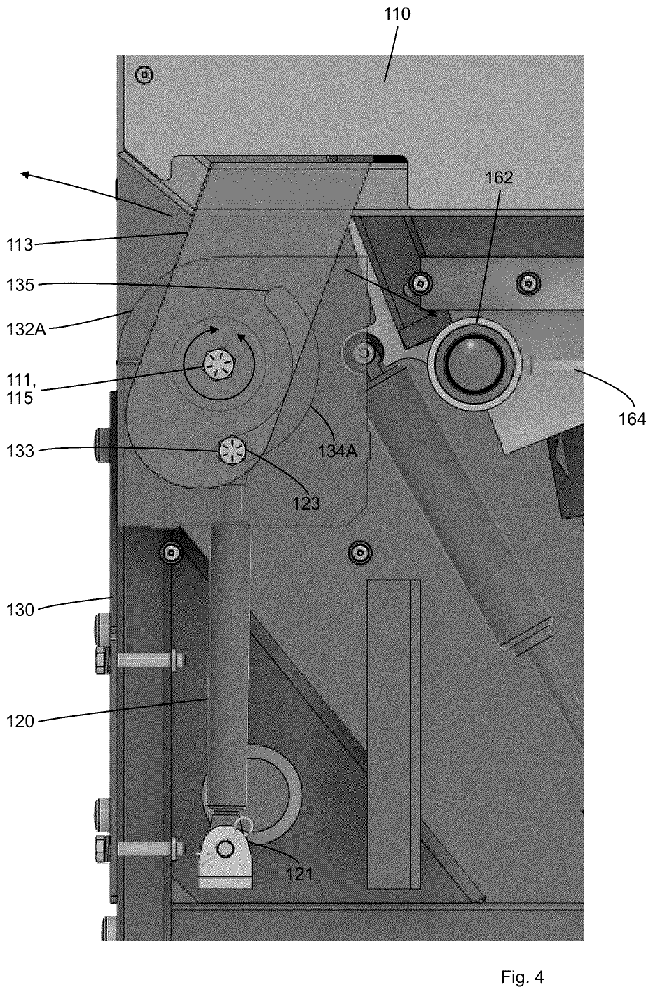

In one aspect, the patient support apparatus 100 may include a lift assist member 120 connected between the frame 130 of the patient support apparatus 100 and the armrest 110. An example configuration with a lift assist member 120 is shown in FIGS. 4-8.

The lift assist member 120 may be operable to aid rotation of the armrest 110 from the armrest position 102 to the raised position 104. The lift assist member 120 may also be operable to allow unassisted rotation of the armrest 110 toward the armrest position 102. For instance, the lift assist member 120 may be configured to allow the armrest 110 to rotate in an unassisted manner toward the armrest position 102 under the force of gravity. The lift assist member 120 may enable such rotation under gravity and enable the armrest 110 to rotate toward the armrest position 102 and to engage the locking mechanism 160 to secure the armrest 110 in the armrest position 102.

The lift assist member 120 in one aspect is a gas lift cylinder operably coupled between the frame 130 of the patient support apparatus 100 and a pivot member 113 of the armrest 110. The pivot member 113 may extend from a lower surface 114 of the armrest 110 into an opening of the patient support apparatus 100, thereby concealing a substantial portion of the pivot member 113 with the armrest 110 in the armrest position 102. At least part of the concealed portions of the pivot member 113 may become visible as the armrest 110 is rotated from the armrest position 102 to the raised position 104.

The pivot member 113 in FIGS. 4, 6, and 8 is shown pivotably joined to frame members 132A, 132B, which may correspond to first and second stationary members of the frame 130. The pivot joint 115 between the pivot member 113 and the frame members 132A, 132B may be provided via a bearing (e.g., a plain bearing) provided by respective apertures in the frame members 132A, 132B and operable to receive a pin 111, such as a bolt, that cooperatively pivotably join the pivot member 113 to the frame members 132A, 132B. The pivot joint 115 may define a pivot axis of rotation that corresponds substantially with a central, longitudinal axis of the pin 111.

In one aspect, a thrust bearing, such as a washer for the pin 111 in the form of a bolt, may be provided in conjunction with the pin 111 to support the pivot member 113 in position with respect to the frame members 132A, 132B.

In one aspect, slots 134A, 134B may be provided in the frame members 132A, 132B. These slots 134A, 134B may be operable to receive a pin 123 that is connected to the lift assist member 120 and the pivot member 113. The slots 134A, 134B in conjunction with the pin 123 may limit movement of the pivot member 113 between first and second ends 133, 135 of the slots 134A, 134B. For instance, contact between the pin 123 and the second end 135 of the slot 134A may limit further rotation of the pivot member 113 about the pivot joint 115 (in a counter clockwise motion relative to the perspective shown in FIGS. 4-8). This limit on rotation of the pivot member 113 may define the raised position 104 of the armrest 110. Conversely, contact between the pin 123 and the first end 133 of the slot 134A may limit rotation of the pivot member 113 about the pivot joint 115 (in a clockwise motion relative to the perspective shown in FIGS. 4-8). Contact between the pin 123 and the first and 133 may define a lowered position of the armrest 110 corresponding to an armrest position 102. Additionally, or alternatively, the armrest position 102 of the armrest 110 may be defined by contact between another portion of the armrest 110 and the patient support apparatus 100, such as contact formed with respect to the locking mechanism 160.

The slots 134A, 134B may be curved such that rotation of the pivot member 113 about the pivot joint 115 provides movement of the pin 123 within the slot 134A, 134B. For instance, the curvature of the slot 134A, 134B may be circular (rather than elliptical) with a radius defined by a distance between the pin 123 and the pivot axis of the pivot joint 115. The pin 123 may be offset from the pivot axis of the pivot joint 115. This offset distance may correspond generally with the radius of curvature of the slots 134A, 134B.

The lift assist member 120 may be connected between the pin 123 and the frame 130 via a pivotable frame joint 121. The lift assist member 120 may be configured to apply force to the pin 123, thereby facilitating rotation of the pivot member 113 and the armrest 110 about the pivot axis of the pivot joint 115. However, in one aspect, the amount of force applied to the pin 123 may be insufficient to raise the armrest 110 without additional external force, such as by a caregiver. As a result, the lift assist member 120 may reduce the amount of external force (e.g., by a caregiver) needed to rotate the armrest 110 from the armrest position 102 to the raised position 104. The amount of force applied by the lift assist member 120 depends on a variety of factors, including a force setting of the lift assist member 120, the offset between the pin 123 and the pivot joint 115, and the direction of force of the lift assist member 120 as the armrest 110 pivots from the armrest position 102 toward vertical and the raised position 104.

The amount of force applied to the pin 123 may allow rotation of the armrest 110 toward the armrest position 102 under the force of gravity. It is noted that rotation of the armrest 110 toward the armrest position 102 may not occur in all positions of the armrest 110. For instance, in FIG. 7, with the armrest 110 in the raised position 104, the center of gravity of the armrest 110 is opposite the side of the armrest position 102, and therefore no force of gravity facilitates rotation in the clockwise direction toward the armrest position 102. As the armrest 110 is rotated from the raised position 104 past vertical, the center of gravity moves further away from vertical and gravity generates more torque on the pivot joint 115. This torque may provide force on the pin 123 that exceeds the amount of force applied by the lift assist member 120 to the pin 123, allowing the armrest 110 to rotate toward the armrest position 102. The force provided by the torque due to gravity may exceed the force applied to the pin 123 by the lift assist member 120. The amount of excess force may be sufficiently small to enable the armrest 110 to rotate slowly toward the armrest position 102. In one aspect, the amount of excess force may be sufficiently large to both overcome the lift assist member 120 and to facilitate unassisted engagement of the locking mechanism 160. This may provide a type of soft latching or soft locking effect for the armrest 110 to rotate smoothly toward the armrest position 102.

### II. Locking Mechanism

In one aspect of the present disclosure, the patient support apparatus 100 may include a locking mechanism 160 operable to facilitate securing the armrest 110 in the armrest position 102, and to release the armrest 110 for rotation toward the raised position 104.

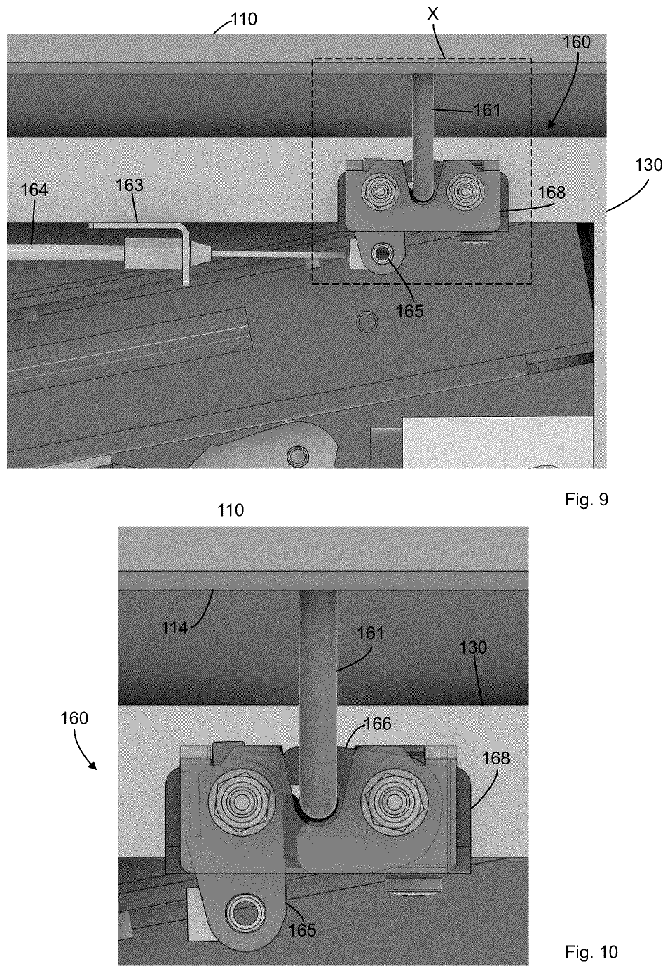

The locking mechanism 160, in one aspect, may be operable by a lock release input 162, which may be manually operated in the form of a push button. The locking mechanism 160 may include a latch 168 configured to releasably secure a striker 161. The latch 168 may be a push-to-close type of latch operable to secure the striker 161 in response the striker 161 engaging the latch 168 as the armrest 110 moves into the armrest position 102. The latch 168 depicted in FIGS. 9 and 10 is a rotary latch; however, the present disclosure is not so limited. The latch 168 may be any type of latch operable to secure and release the armrest 110 with respect to the armrest position 102.

The striker 161 in one aspect may be attached to the armrest 110 and extend from the lower surface 114 of the armrest 110. The striker 161 in FIGS. 9 and 10 includes a U-shaped construction and is attached at each end to the armrest 110; however, the striker 161 may be configured differently depending on the application, including for instance as an L-shaped member. Although the striker 161 is described as extending from the armrest 110, alternatively, the striker 161 may be attached to the frame 130 of the patient support apparatus 100.

The lock release input 162 may be configured activate the latch 168 to release the striker 161, thereby releasing the armrest 110 for rotation toward the raised position 104. The lock release input 162 may be a push button operably coupled to a control cable 164, such as a Bowden cable, with an inner cable and an outer sleeve. The control cable 164 may be operable to translate movement of the lock release input 162 into movement that operates the latch 168 to release the striker 161. For instance, the lock release input 162 may be configured to move a first end of an inner cable of the control cable 164 to move an opposing second end of the control cable 164. The opposing second end may be connected to a latch release 165 of the latch 168, and movement of the inner cable via the lock release input 162 may pull the latch release 165 in order to enable rotation of a latching member 166, thereby releasing the striker 161 from the latch 168. The control cable 164 may be coupled to a mounting bracket 163 connected to the frame 130 and operable to maintain a position of the outer sleeve of the control cable 164, ensuring that movement of the inner cable via the lock release input 162 translates to a pulling force on the latch release 165 and release of the striker 161.

The latching member 166 may include a receiver operable to receive and engage the striker 161, and to rotate to a latched position in response to engaging the striker 161. After the latching member 166 has been released by the latch release 165 (e.g., a latch actuator), the latching member 166 may be positioned so that the receiver is operable to engage the striker 161.

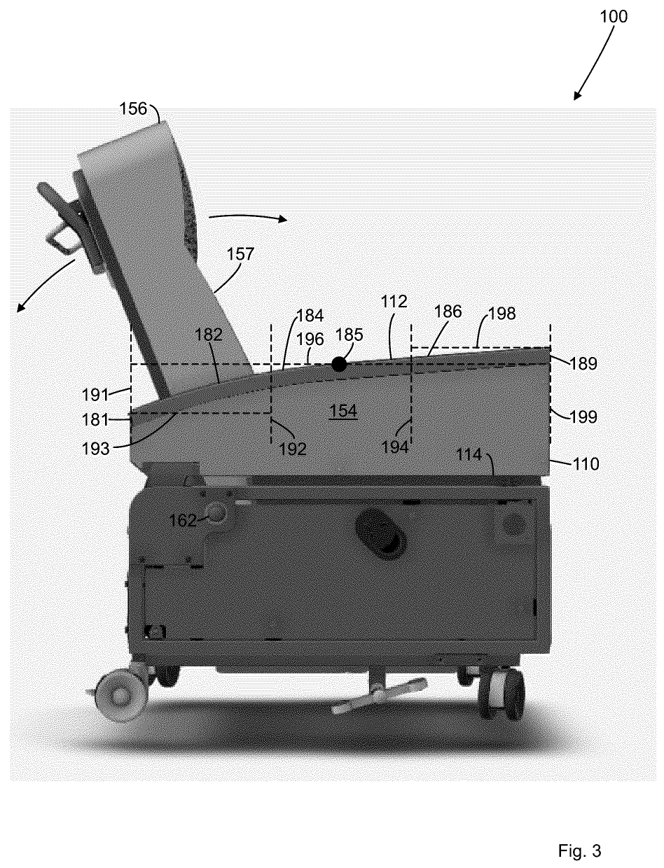

The lock release input 162 is a manually operable release and may be positioned substantially out of reach with respect to a patient sitting in the patient support apparatus 100. This positioning may limit the ability of the patient to operate the locking mechanism 160. The armrest 110, as described herein, is operable to be rotated to a raised position 104 that enables a patient to egress laterally from the patient support apparatus 100. In an effort to avoid the patient operating the lock release input 162 in order to raise the armrest 110, the lock release input 162 may be positioned in a manner that is generally inaccessible to the patient when the patient is sitting on the seat 150 and facing forward. For instance, as depicted in FIG. 3, the lock release input 162 is positioned rearward of the back support surface 157, and below the lower surface 114 of the armrest 110. The lock release input 162 in one aspect may be disposed within a region of the patient support apparatus 100 defined by a rear segment 182 of the arm support surface 112 (e.g., between a rear end 181 of the patient support apparatus 100 and a first boundary 192 between the rear segment 182 and a medial segment 184 of the arm support surface 112.

### III. Arm Support Surface

In one aspect of the present disclosure, the patient support apparatus 100 may include an arm support surface 112 configured to facilitate ingress and egress relative to a front portion 108 of the patient support apparatus 100. The arm support surface 112 may be formed by material that is overmolded with respect to an internal structure of the armrest 110.

The arm support surface 112 may include a rear segment 182, a medial segment 184, and forward segment 186. With respect to the armrest 110 being in the armrest position 102, the rear segment 182 may be proximal to the backrest 156, the forward segment 186 may be distal from the backrest 156, and the medial segment 184 may be between the rear and forward segments 182, 186. The medial segment 184 may include a midpoint 185 of the arm support surface 112 between a rear end 181 and a forward end 189 (e.g., first and second ends). The overall length of the arm support surface 112 may be longer than a straight-line distance between the rear end 181 and the forward end 189.

The arm support surface 112 may vary depending on the application, and is not limited to any particular arrangement of constructions or aspects described herein. For instance, the armrest 110 may be constructed according to a subset of aspects described herein.

In one aspect, the rear segment 182, the medial segment 184, and the forward segment 186 may be defined with respect to three regions of the armrest 110: a rear region, a medial region, and a forward region. These regions may be defined by boundaries provided and defined with respect to features of the patient support apparatus 100. For instance, a forward boundary 199 may correspond to a forwardmost portion of the armrest 110, and a rear boundary 191 may correspond to a rearmost portion of the armrest 110. First and second boundaries 192, 194 may be provided between the forward boundary 199 and the rear boundary 191, and are shown in FIG. 3 with spacing between the forward boundary 199 and the rear boundary 191. The spacing may or may not be equal, and the first and second boundary 192, 194 locations may vary depending on the application. The spacing may be based on a variety of factors and is not limited to proportions. For instance, the spacing between the forward boundary 199 and the second boundary 194 may be defined by a feature or aspect of the patient support apparatus 100. As another example, the spacing may be defined according to one or more anatomical parameters associated with a patient likely to use the patient support apparatus 100. As described, the spacing between the rear boundary 191 and the first boundary 192 and the spacing between the forward boundary 199 and the second boundary 194 may vary depending on the application, and therefore, the relative proportions of the rear, medial, and forward regions may vary and need not be equal.

In one aspect, in FIG. 3, the second boundary 194 corresponds generally to a wrist area of the patient and the first boundary 192 corresponds generally to an elbow area of the patient, with the patient sitting in the seat 150 with their arm resting on the arm support surface 112. It is noted that anatomical parameters, such as elbow location, forearm length, and wrist location of patients may vary. So that the patient support apparatus 100 is functional for different patients, the locations of the first and second boundaries 192, 194 may align with approximations of the elbow and wrist locations for various patient sizes and types. As mentioned herein, the second boundary 194 and the first boundary 192 may be positioned according to factors different from the likely wrist and elbow areas of a patient.

The midpoint 185 of the arm support surface 112 may define a longitudinal axis 196 that is horizontal. In one aspect, the arm support surface 112 may slope upward from the midpoint 185 to the forward end 189. Additionally, or alternatively, the upward slope may be greater with respect to the arm support surface 112 between the second boundary 194 and the forward boundary 199 relative to the slope of the arm support surface 112 between the midpoint 185 and the second boundary 194. The upward slope of the arm support surface 112 between the midpoint 185 and the forward end 189 and/or the upward slope between the second boundary 194 and the forward boundary 199 may facilitate ingress and egress from the patient support apparatus 100. In one aspect, the upward slope may be nonlinear and curved. For instance, the upward slope may correspond to a type of upward wave or curve.

In one aspect, the forward segment 186 being higher than the medial segment 184 and/or higher than the longitudinal axis 196. The height difference in either case may be sufficient to facilitate ingress and egress from the patient support apparatus 100. The uppermost portion of the forward segment 186 may define an upper axis 198, which is shown higher than the longitudinal axis 196 and higher than the medial segment 184 in FIG. 3.

The height of the arm support surface 112 proximal to the forward end 189 may be sufficient to provide leverage for the patient to egress and ingress more easily from the patient support apparatus 100. For instance, from a standing position or with a slight bend in the knees and hips, the patient may be able to rest their hand on the arm support surface 112 and support themselves as they ingress with respect to the patient support apparatus 100. An example height of the arm support surface 112 is approximately 29.75 inches. The height proximal to the medial region and/or the midpoint 185 may be lower and more configured to provide a comfortable rest height for the arms of the patient. An example of such a height is approximately 28.5 inches.

In FIG. 3, in one aspect, the rear segment 182 of the arm support surface 112 may be lower than the medial segment 184 and/or lower than the longitudinal axis 196. The lowermost portion of the arm support surface 112 may define a lower axis 193, which is shown lower than the longitudinal axis 196 and lower than the medial segment 184 in FIG. 3.

In one aspect, the rear segment 182 of the arm support surface 112 may slope downward from the midpoint 185 to the rear end 181. Additionally, or alternatively, the downward slope may be greater with respect to the arm support surface 112 between the first boundary 192 and the rear boundary 191 relative to the slope of the arm support surface 112 between the midpoint 185 and the first boundary 192. The downward slope of the arm support surface 112 between the midpoint 185 and the rear end 181 and/or the downward slope between the first boundary 192 and the rear boundary 191 may provide support for the arm of the user with the back support surface 157 in a reclined position.

Directional terms, such as “vertical,” “horizontal,” “top,” “bottom,” “upper,” “lower,” “inner,” “inwardly,” “outer” and “outwardly,” are used to assist in describing embodiments of the present disclosure based on the orientation of the embodiments shown in the illustrations. The use of directional terms should not be interpreted to limit embodiments to any specific orientation(s).

The above description is that of current embodiments of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all embodiments of the disclosure or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present disclosure is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

While several forms have been shown and described, other changes and modifications will be appreciated by those skilled in the relevant art. Therefore, it will be understood that the embodiments shown in the drawings and described above are merely for illustrative purposes, and are not intended to limit the scope of the disclosure which is defined by the claims which follow as interpreted under the principles of patent law including the doctrine of equivalents.

1. A patient support apparatus comprising:
a frame;
a stationary member mounted relative to the frame;
an armrest rotatably mounted to the stationary member, the armrest being rotatable between an armrest position and a raised position; and
a lift assist member connected between the frame and the armrest, the lift assist member operable to aid rotation of the armrest from the armrest position to the raised position, the lift assist member operable to allow unassisted rotation of the armrest toward the armrest position.

2. The patient support apparatus of claim 1 comprising:
a seat operable to support a patient between first and second opposing sides of the patient support apparatus, the seat including an upper support surface; and
a backrest operable to support a back of the patient between the first and second opposing sides of the patient support apparatus, the backrest including a back support surface.

3. The patient support apparatus of claim 2 wherein, in the raised position, the armrest provides unobstructed access for the patient between one of the first and second opposing sides and the upper support surface and the back support surface, whereby, with the armrest in the raised position, the patient is free to ingress or egress to one of the first and second opposing sides of the patient support apparatus.

4. The patient support apparatus of claim 2 wherein, with the armrest in the raised position, a lower surface of the armrest provides unobstructed access to the back support surface from one of the first and second opposing sides, and wherein, with the armrest in the armrest position, an upper surface of the armrest provides an arm support surface for the patient.

5. The patient support apparatus of claim 2 wherein the backrest is operable to pivot away from the seat to allow the patient to sit in a reclined position.

6. The patient support apparatus of claim 1 wherein the lift assist member is an assist linkage connected between the frame and the armrest.

7. The patient support apparatus of claim 6 wherein the assist linkage is operatively coupled to a pivot member of the armrest.

8. The patient support apparatus of claim 7 wherein a pivot joint is provided between the pivot member and the stationary member to facilitate rotation of the armrest about a pivot axis of the pivot joint.

9. The patient support apparatus of claim 8 comprising:
a pin offset from the pivot axis of the pivot joint; and
a curved slot operable to receive the pin, the curved slot including a first end configured to engage the pin to limit rotation of the armrest about the pivot axis.

10. The patient support apparatus of claim 1 comprising:
a locking mechanism operable to secure and release the armrest from the armrest position;
a striker receivable by the locking mechanism to secure the armrest in the armrest position; and
a manually operable release coupled to the locking mechanism, the manually operable release configured to operate the locking mechanism to release the striker and allow the armrest to rotate toward the raised position.

11. The patient support apparatus of claim 10 wherein the locking mechanism is connected to the frame, and the striker is connected to the armrest.

12. A patient support apparatus comprising:
a frame;
a stationary member mounted relative to the frame;
an armrest rotatably mounted to the stationary member, the armrest being rotatable between an armrest position and a raised position;
a locking mechanism operable to secure and release the armrest from the armrest position;
a striker receivable by the locking mechanism to secure the armrest in the armrest position; and
a manually operable release coupled to the locking mechanism, the manually operable release configured to operate the locking mechanism to release the striker and allow the armrest to rotate toward the raised position.

13. The patient support apparatus of claim 12 wherein the locking mechanism is connected to the frame, and the striker is connected to the armrest.

14. The patient support apparatus of claim 12 wherein the manually operable release is positioned substantially out of reach with respect to a patient sitting in the patient support apparatus to limit an ability of the patient to operate the locking mechanism to move the armrest from the armrest position.

15. A patient support apparatus comprising:
a frame;
a stationary member mounted relative to the frame;
a backrest operable to support a back of a patient between first and second opposing sides of the patient support apparatus, the backrest including a back support surface;
a seat operable to support the patient between the first and second opposing sides of the patient support apparatus, the seat including an upper support surface provided between the back support surface and a front portion of the patient support apparatus; and
an armrest rotatably mounted to the stationary member, the armrest being rotatable between an armrest position and a raised position, the armrest including an arm support surface configured to support an arm of the patient, the arm support surface including a rear segment proximal to the backrest, a forward segment distal from the backrest, and a medial segment between the rear segment and the forward segment, the forward segment being higher than the medial segment relative to the upper support surface.

16. The patient support apparatus of claim 15 wherein the forward segment is sloped upward from a first portion of the forward segment that is proximal to the medial segment to a second portion of the forward segment that is distal from the medial segment.

17. The patient support apparatus of claim 15 wherein the medial segment includes a midpoint of the arm support surface between a first end of the arm support surface that is proximal to the backrest and a second end of the arm support surface that is distal from the backrest.

18. The patient support apparatus of claim 15 wherein the rear segment slopes downward from a first portion of the rear segment that is proximal to the medial segment to a second portion of the rear segment that is distal from the medial segment.

19. The patient support apparatus of claim 15 wherein the forward segment is raised relative to the medial segment and facilitates ingress and egress with respect to the patient support apparatus.

20. The patient support apparatus of claim 15 comprising a lift assist member connected between the frame and the armrest, the lift assist member operable to aid rotation of the armrest from the armrest position to the raised position, the lift assist member operable to allow unassisted rotation of the armrest toward the armrest position.
